(19) United States
(12) Patent Application Publication
(10) Pub. No.: US 2026/0366560 A1
(43) Pub. Date: Nov. 19, 2026

(54) SCREW

(71) Applicant: Spax International GmbH & Co. KG, Ennepetal (DE)

(72) Inventors: Frank Langewiesche, Sprockhövel (DE); Jacek Romanko, Ennepetal (DE)

(21) Appl. No.: 19/124,123

(22) PCT Filed: Oct. 18, 2023
(86) PCT No.: PCT/EP2023/078976

§ 371 Date: Apr. 24, 2025

(30) Foreign Application Priority Data
Oct. 27, 2022 (EP) 22204159.2
Dec. 16, 2022 (EP) 22214057.6

(51) Int. Cl. F16B 25/00

(52) U.S. Cl. CPC F16B 25/0084

(57) ABSTRACT

A screw having a thread and a tapered tip, where a cylindrical shaft is formed behind the tip, and where a thickened portion is arranged behind the shaft.

### CROSS REFERENCE TO RELATED APPLICATION

The present application is a national stage application of International Patent Application No. PCT/EP2023/078976, filed Oct. 18, 2023, and claims benefit of European applications EP22204159.2, filed Oct. 27, 2022, and EP22214057.6, filed Dec. 16, 2022.

### BACKGROUND AND FIELD OF THE INVENTION

The invention relates to a screw.

Screws, in particular wood screws, exist in different varieties in the prior art. However, conventional screws have the following disadvantages. When conventional screws are screwed into the material, they have the disadvantage of causing the wood to split. In addition, with conventional screws, there is a high level of friction when the screws are inserted.

### SUMMARY OF THE INVENTION

The object of the present invention is to eliminate the disadvantages of the prior art.

This object is achieved with the subject of the independent claims. Advantageous further developments of the invention are given in the dependent claims. All combinations of at least two features given in the description, claims and/or figures also fall within the scope of the invention. In the specified value ranges, values lying within the specified limits are also to be disclosed as limit values and can be claimed in any combination.

The invention relates to a screw, in particular wood screw, having a thread and a tapered tip, wherein a cylindrical shaft is formed behind the tip, wherein a thickened portion is arranged behind the shaft.

By virtue of the fact that a cylindrical shaft and a thickened portion are arranged behind the tip, it is advantageously possible that the material, in particular the wood, into which the screw is screwed, is cut through and splitting of the material, in particular of the wood, is reduced.

The screw has a longitudinal axis in a conventional manner. The screw extends along this longitudinal axis from a head with a drive to the tip. The characteristics “behind” and “in front” are defined in such a way that the rear part of the screw is provided with the head and the front part of the screw is provided with the tip. The characteristic that the cylindrical shaft is arranged behind the tip should be understood as meaning that the cylindrical shaft is located behind the tip in the longitudinal direction as seen from the front tip. The terms “thread depth” and “pitch of the thread” are known to a person skilled in the art.

The thread extends in a conventional manner between the head and the tip. A further cylindrical shank can be located between the head and the thread, which has a diameter that is larger than the core diameter of the thread. The characteristic of the core diameter of the thread is known to a person skilled in the art.

The thread can extend in a conventional manner up to the front end of the tip. Alternatively, a region where there is no thread can be arranged at the front end of the tip.

In one preferred embodiment, it is provided that the thickened portion is cylindrical, in particular annular, in particular circular. Alternatively, it can be provided that the thickened portion is conical, wherein the thickened portion preferably gets wider towards the tip. In general, the thickened portion can also have other spherical shapes.

In another preferred embodiment, it is provided that a step is arranged behind the shaft, wherein the step is preferably arranged at an angle of 60° to 120° to the screw longitudinal axis, wherein the step is particularly preferably arranged perpendicular to the screw longitudinal axis. The provision of a step advantageously makes it possible for the wood to be widened by the step when the screw is screwed in such that the friction can be reduced when the screw is screwed in further.

In another preferred embodiment, it is provided that a diameter of the thickened portion is between 10% and 50% of a thread depth of the thread.

In another preferred embodiment, it is provided that the thickened portion has a length in the direction of the screw longitudinal axis, wherein the length is less than 5 times a pitch of the thread.

In another preferred embodiment of the invention, it is provided that the screw has at least one further thickened portion, wherein the at least one further thickened portion is arranged on the end of the thread, preferably at the transition to a shank on a head of the screw, and/or is arranged in a region of the thread, preferably in the centre of the region.

This at least one further thickened portion can be used to widen the hole or opening into which the screw is screwed. This can reduce the friction generated by the adjoining shaft.

In particular, the shaft can be circular-cylindrical or polygonal.

The information provided above for the thickened portion applies accordingly to the at least one further thickened portion.

The at least one further thickened portion can be identical to the thickened portion. However, the at least one further thickened portion can also have a different design than the thickened portion.

In another preferred embodiment of the invention, it is provided that the at least one further thickened portion is cylindrical, in particular annular, in particular circular.

In another preferred embodiment of the invention, it is provided that the at least one further thickened portion is conical, wherein the at least one further thickened portion preferably gets wider towards the tip. This can widen the hole or opening, which can reduce friction in the further process.

In another preferred embodiment of the invention, it is provided that a step is arranged on the at least one further thickened portion, wherein the step is preferably arranged at an angle of 60°-120° to the screw longitudinal axis, wherein the step is particularly preferably arranged perpendicular to the screw longitudinal axis.

In another preferred embodiment of the invention, it is provided that a diameter of the at least one further thickened portion is between 10% and 50% of the thread depth of the thread.

In another preferred embodiment of the invention, it is provided that the at least one further thickened portion has a length in the direction of the screw longitudinal axis, wherein the length is less than 5 times the pitch of the thread.

The information provided about the thickened portion applies in particular in terms of the advantages and further aspects of the at least one further thickened portion.

Further advantages, features and details of the invention result from the following description of preferred exemplary embodiments as well as based on the schematic drawings.

### BRIEF DESCRIPTION OF THE DRAWINGS

FIG. 1a schematically shows a screw according to the invention in accordance with a first embodiment;

FIG. 1b shows a section of the screw from FIG. 1a, wherein the screw has been turned 120° clockwise about the longitudinal axis;

FIG. 1c shows the section of the screw from FIG. 1b, wherein the screw has been turned 120° clockwise about the longitudinal axis;

FIG. 2a schematically shows a screw according to the invention in accordance with a second embodiment;

FIG. 2b shows similarly to FIG. 1b a section of the screw from FIG. 2a, wherein the screw has been turned 120° clockwise along the longitudinal axis;

FIG. 2c shows similarly to FIG. 1c the section of the screw from FIG. 2b, wherein the screw has been turned 120° clockwise along the longitudinal axis;

FIG. 3a schematically shows a screw according to the invention in accordance with a third embodiment;

FIG. 3b shows a section of the screw from FIG. 3a; and

FIG. 4 schematically shows a screw according to the invention in accordance with a fourth embodiment.

### DESCRIPTION OF THE PREFERRED EMBODIMENTS

In the figures, advantages and features of the invention are marked with reference numbers identifying these in each case according to embodiments of the invention, wherein components or features with the same or equivalent function are marked with identical reference numbers.

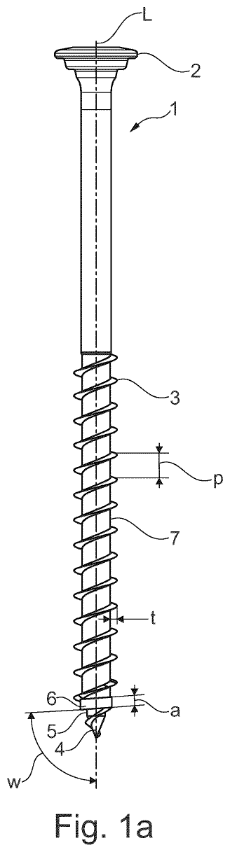

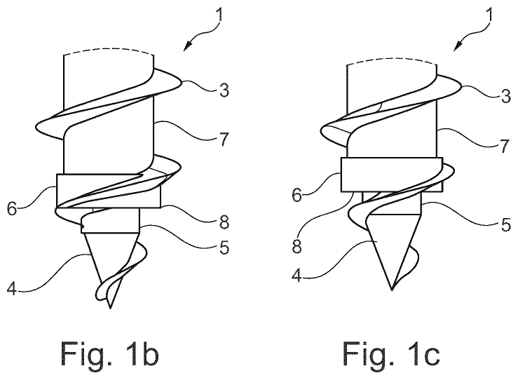

FIGS. 1a, 1b and 1c schematically show a screw 1 according to the invention in accordance with a first embodiment of the invention. The screw 1 extends along a screw longitudinal axis L. At the rear end of the screw, there is a head 2 with a conventional drive for a suitable actuating tool.

In front of the head, there is a cylindrical shank with a diameter, wherein the diameter of this shank is greater than the core diameter of a thread 3, which is arranged in a region 7. The region 7 with the thread 3 is located in front of the cylindrical shank as seen in the longitudinal direction L. A chamfer is arranged between the cylindrical shank and the region 7 with the thread 3 such that the wider diameter of the shank tapers to the core diameter of the thread 3 in the region 7.

The thread 3 has a pitch P. In addition, the thread 3 has a thread depth t.

Furthermore, the screw 1 extends up to a front end, where there is a tapered tip 4.

A cylindrical shaft 5, the length a of which is less than the pitch P of the thread 3, extends behind the tip 4. A cylindrical thickened portion 6 is arranged behind the cylindrical shaft 5, wherein the length a of the thickened portion 6 is less than the pitch P. A step 8 is arranged between the cylindrical shaft 5 and the cylindrical thickened portion 6, wherein, in this exemplary embodiment, this step 8 is arranged at an angle of 90° to the longitudinal axis L. Behind the cylindrical thickened portion 6, there is the region 7 with the thread 3, wherein the core diameter of the thread 3 is smaller than the diameter of the thickened portion 6.

In this exemplary embodiment, the thread 3 extends in the longitudinal direction L beyond the thickened portion 6 and also beyond the cylindrical shaft 5 to the front end of the tip 4. Detail views and rotated views are shown in FIGS. 1b and 1c.

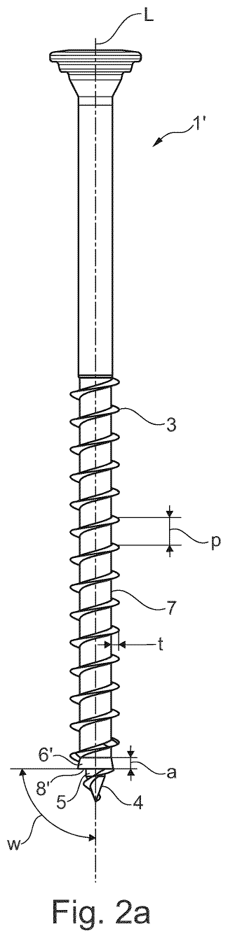

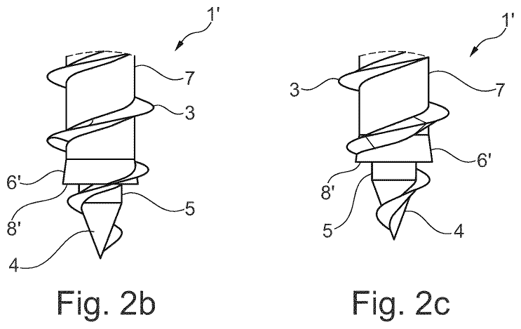

FIGS. 2a, 2b and 2c schematically show a second embodiment according to the invention of the present invention. The screw 1′ extends along a screw longitudinal axis L as in the first embodiment from a head 2 with a drive to a tapered tip 4 in the front region of the screw 1′. Most of the features in the second embodiment are similar to the features and description of the first embodiment. The second embodiment has the following differences compared to the first embodiment.

As in the first embodiment, the screw 1′ has a thickened portion 6′. In contrast to the first embodiment, the thickened portion 6′ is conically widening, wherein the diameter of the thickened portion 6′ gets bigger towards the tip. The conical thickened portion 6′ thus starts in its rear region with the diameter of the core diameter of the thread 3 and widens into a larger diameter.

As in the first embodiment, behind the tip 4, there is the cylindrical shaft 5 with an extension in the longitudinal direction L that is less than the pitch P of the thread 3. As in the first embodiment, there is a step 8′ between the cylindrical shaft 5 and the thickened portion 6′, wherein the step 8′ extends at any angle of 90° to the longitudinal axis L. The thickened portion 6′ extends in the longitudinal direction L along a length a, wherein the length a in this exemplary embodiment is less than the pitch P of the thread 3. For the rest, reference is made to the explanations on the first embodiment.

FIGS. 2b and 2c show rotated views of the front region of the screw 1′ with the tip 4.

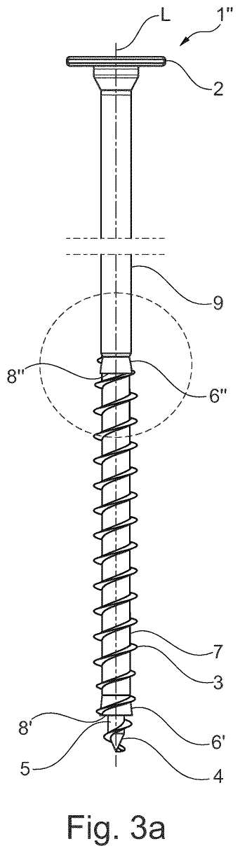

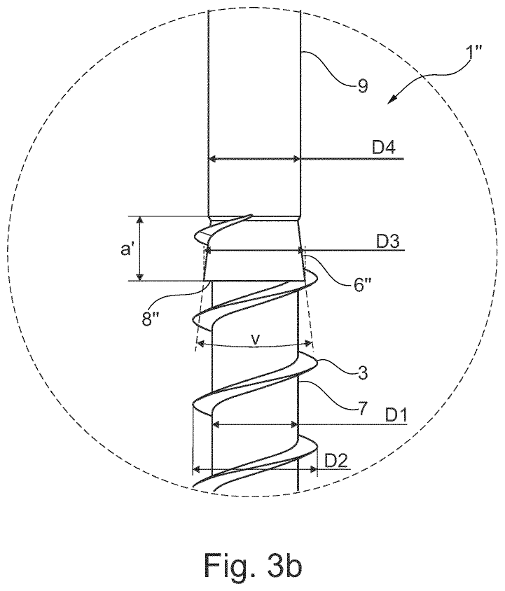

FIG. 3a schematically shows a screw 1″ according to the invention in accordance with a third embodiment. The screw 1″ has a thickened portion 6′ according to the invention on the tip 4, which is similar to the design in FIGS. 2a-2c in this example. In this respect, reference is made to the explanations on these figures.

In this preferred exemplary embodiment, the screw 1″ has a further thickened portion 6″, which is arranged on the rear end of the region 7 with the thread 3 and is arranged at the transition to a shank 9, wherein the shank 9 can be cylindrical or polygonal, for example. In this special embodiment, the further thickened portion 6″ is similar in design to the thickened portion 6′ on the tip 4; in this respect, reference is made to the explanations on FIGS. 2a-2c. The further thickened portion 6″ thus widens conically towards the tip 4.

Thanks to the further thickened portion 6″, this embodiment has the advantage that the opening into which the screw 1″ is screwed is widened by the further thickened portion 6″ before the shank 9 reaches the opening, which can significantly reduce friction and resistance.

FIG. 3b shows a section of the screw 1″ from FIG. 3a, which is marked with a circle in FIG. 3a. FIG. 3b shows that the diameter D4 of the shank 9 is smaller than the maximum diameter D3 of the further thickened portion 6″. As a result, the opening into which the screw is screwed is advantageously widened. Further shown is the core diameter D1 of the region 7 with the thread 3, as well as the thread diameter D2 of the thread 3.

The further thickened portion 6″ extends along a length a′ and widens out at an angle v. The angle v is the angle between the extensions of the outer contour of the further thickened portion 6″. The angle v is 5-30 °. In addition, a step 8″, which runs perpendicular to the longitudinal axis L of the screw 1″, extends at the front end of the further thickened portion 6″. The maximum diameter D3 is at this step 8″.

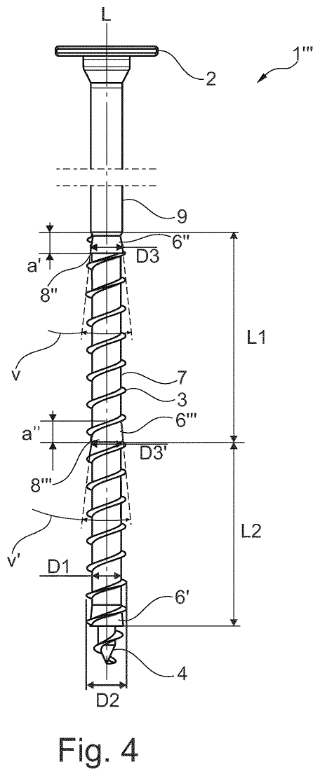

FIG. 4 schematically shows a screw 1″′ according to the invention in accordance with a fourth embodiment. Similarly to the embodiment of FIGS. 3a and 4b, the screw has a conical thickened portion 6′ in the region of the tip 4. Furthermore, the screw 1″′ has a further thickened portion 6″ in the rear part of the region 7 with the thread 3 at the transition to the shank 9. In this respect, reference is made to the above explanations.

In this special embodiment, the screw 1″′ has a further third thickened portion 6″′, which is arranged centrally in the region 7 with the thread 3. This embodiment thus has a total of three thickened portions 6′, 6″, 6″′.

The third thickened portion 6″′ extends in the direction of the longitudinal axis L along a length a″ and widens out conically towards the tip 4 at an angle v′. The angle v′ is 5-30 °. The angle v′ is the angle between the extensions of the outer contour of the further thickened portion 6″′. The third thickened portion 6″′ has a maximum diameter of D3′ at the widest point. Diameter D3′ is larger than diameter D1 of the region 7.

In addition, a step 8″′, which runs perpendicular to the longitudinal axis L of the screw 1″′, extends at the front end of the third thickened portion 6″′. The maximum diameter D3′ is at this step 8″′.

The exemplary embodiments set out above merely serve to illustrate the invention and to provide a better understanding of the basic idea. The exemplary embodiments are in no way intended to limit the general idea of the invention.

1. A screw, said screw comprising a thread and a tapered tip, wherein a cylindrical shaft is formed behind the tip, and wherein a thickened portion is arranged behind the shaft.

2. The screw according to claim 1, wherein the thickened portion is cylindrical.

3. The screw according to claim 1, wherein the thickened portion is conical, and wherein the thickened portion gets wider towards the tip.

4. The screw according to claim 1, wherein a step is arranged behind the shaft, and wherein the step is arranged at an angle of 60 °-120 ° to a longitudinal axis of the screw.

5. The screw according to claim 1, wherein a diameter of the thickened portion is between 10% and 50% of a thread depth of the thread.

6. The screw according to claim 1, wherein the thickened portion has a length in the direction of the screw longitudinal axis, and wherein the length is less than 5 times a pitch of the thread.

7. The screw according to claim 1, further comprising at least one further thickened portion, and wherein the at least one further thickened portion is arranged on the end of the thread at the transition to a shank on a head of the screw, and/or is arranged in a region of the thread.

8. The screw according to claim 7, wherein the at least one further thickened portion is cylindrical.

9. The screw according to claim 7, wherein the at least one further thickened portion is conical, and wherein the at least one further thickened portion gets wider towards the tip.

10. The screw according to claim 7, wherein a step is arranged on the at least one further thickened portion, and wherein the step is arranged at an angle of 60°-120° to the screw longitudinal axis.

11. The screw according to claim 7, wherein a diameter of the at least one further thickened portion is between 10% and 50% of a thread depth of the thread.

12. The screw according to claim 7, wherein the at least one further thickened portion has a length in the direction of the screw longitudinal axis, and wherein the length is less than 5 times a pitch of the thread.

13. A screw, said screw comprising a thread and a tapered tip, wherein a cylindrical shaft is formed behind the tip and a thickened portion is arranged behind the shaft, wherein the thickened portion is cylindrical, wherein a step is arranged behind the shaft, and wherein the step is arranged at an angle of 60°-120° to a longitudinal axis of the screw.

14. The screw according to claim 13, wherein a diameter of the thickened portion is between 10% and 50% of a thread depth of the thread, and wherein the thickened portion has a length in the direction of the screw longitudinal axis, and wherein the length is less than 5 times a pitch of the thread.

15. The screw according to claim 13, further comprising at least one further thickened portion, and wherein the at least one further thickened portion is arranged on the end of the thread at the transition to a shank on a head of the screw, and/or is arranged in a region of the thread.

16. The screw according to claim 15, wherein the at least one further thickened portion is one of either (i) cylindrical or (ii) conical with the at least one further thickened portion getting wider towards the tip.

17. A screw, said screw comprising a thread and a tapered tip, wherein a cylindrical shaft is formed behind the tip and a thickened portion is arranged behind the shaft, wherein the thickened portion is conical and gets wider towards the tip, wherein a step is arranged behind the shaft, and wherein the step is arranged at an angle of 60°-120° to a longitudinal axis of the screw.

18. The screw according to claim 17, wherein a diameter of the thickened portion is between 10% and 50% of a thread depth of the thread, and wherein the thickened portion has a length in the direction of the screw longitudinal axis, and wherein the length is less than 5 times a pitch of the thread.

19. The screw according to claim 17, further comprising at least one further thickened portion, and wherein the at least one further thickened portion is arranged on the end of the thread at the transition to a shank on a head of the screw, and/or is arranged in a region of the thread.

20. The screw according to claim 19, wherein the at least one further thickened portion is one of either (i) cylindrical or (ii) conical with the at least one further thickened portion getting wider towards the tip.
